(19) United States
(12) Patent Application Publication
(10) Pub. No.: US 2018/0142605 A1
(43) Pub. Date: May 24, 2018

(54) ACTIVE AIR FLAP CONTROL APPARATUS FOR A VEHICLE AND METHOD THEREOF

(71) Applicants: HYUNDAI MOTOR COMPANY, Seoul (KR); KIA MOTORS CORPORATION, Seoul (KR)

(72) Inventors: Jee Wook HUH, Bucheon-si (KR); Yong Hoon LEE, Incheon (KR); Chun Hyuk LEE, Suwon-si (KR)

(73) Assignees: HYUNDAI MOTOR COMPANY, Seoul (KR); KIA MOTORS CORPORATION, Seoul (KR)

(21) Appl. No.: 15/586,567

(22) Filed: May 4, 2017

(30) Foreign Application Priority Data
Nov. 23, 2016 (KR) 10-2016-0156518

(51) Int. Cl. F01P 7/12; B60K 11/08

(52) U.S. Cl. CPC F01P 7/12; B60K 11/085

(57) ABSTRACT

An active air flap control apparatus for a vehicle and an active air flap control method are provided. The active air flap control apparatus includes: a storing unit storing a plurality of critical values with respect to each of a cooling water temperature, a refrigerant pressure, and an intake air temperature; a first sensor measuring the cooling water temperature; a second sensor measuring the refrigerant pressure; a third sensor measuring the intake air temperature; and a controller combining the measured cooling water temperature, the measured refrigerant pressure, and the measured intake air temperature with each other. Based on the plurality critical values stored in the storing unit, the controller determines an opening rate of an active air flap.

### CROSS-REFERENCE TO RELATED APPLICATION

This application claims priority to and the benefit of Korean Patent Application No. 10-2016-0156518, filed on Nov. 23, 2016, which is incorporated herein by reference in its entirety.

### FIELD

The present disclosure relates to an active air flap (AAF) control apparatus for a vehicle and an active air flap control method thereof.

### BACKGROUND

The statements in this section merely provide background information related to the present disclosure and may not constitute prior art.

In general, various heat exchangers, such as a radiator, an intercooler, an evaporator, a condenser, etc., are placed in an engine compartment of a vehicle in addition to components for driving the vehicle, e.g., an engine.

The heat exchangers include a heat exchange medium flowing therein, and cooling or heat dissipation is achieved by the heat exchange medium in the heat exchanger and an external air exchanging a heat with the heat exchange medium.

Accordingly, to allow the heat exchangers in the engine compartment of the vehicle to be stably operated, the external air is desired to be supplied smoothly into the engine compartment.

However, in a case that a large amount of the external air enters into the engine compartment at high speed when the vehicle drives at high speed, an air resistance becomes very large, and thus a fuel efficiency is deteriorated.

To solve the above, an active air flap (AAF) control system that increases the degree of opening of an air inlet passage when the vehicle drives at low speed to allow an air inlet into the engine compartment to increase and decreases the degree of opening of the air inlet passage when the vehicle drives at high speed to allow the air inlet into the engine compartment to decrease is applied to improve an aerodynamic performance and the fuel efficiency.

The AAF control system is installed at a position at which the external air enters to change the degree of the opening of the air inlet passage depending on vehicle's operating system, thereby actively controlling the air inlet.

Hereinafter, a structure of a conventional AAF control system will be described with reference to FIGS. 1 and 2. FIG. 1 is a front view showing an AAF control system installed at a radiator grill of the vehicle, and FIG. 2 is a side view showing the AAF control system installed at the radiator grill of the vehicle.

Referring to FIGS. 1 and 2, the AAF control system includes a duct 2 coupled to a front end module 1 of the vehicle to guide a flow of air, a housing 3 coupled to the duct 2, an actuator 4 fixed to the housing 3, and an air flap 6 rotatably coupled to the housing 3 and rotated by power of the actuator 4 to open or close an air inlet passage 5 of the housing 3.

Here, the actuator 4 includes a motor and a plurality of gear members (reduction gears), and a rotating shaft 7 rotatable with respect to the housing 3 is installed at both sides of the actuator 4.

The gear members are connected to the rotating shaft 7 for power transmission, the air flap 6 is integrally coupled to the rotating shaft 7, and the rotating shaft 7 and the air flap 6 are substantially simultaneously rotated when the actuator 4 is operated, thereby opening or closing the air inlet passage 5 of the housing 3.

In the conventional AAF control system, variables needed to determine an opening rate of the air flap are not subdivided. In particularly, we have discovered that the opening rate of the air flap is not determined based on a relation between the variables so that a cooling performance, the aerodynamic performance, and the fuel efficiency are deteriorated.

### SUMMARY

The present disclosure addressed the above-mentioned problems occurring in the prior art while advantages achieved by the prior art are maintained intact.

An aspect of the present disclosure provides an active air flap (AAF) control apparatus for a vehicle and an active air flap (AAF) control method thereof, which are capable of improving a cooling performance, an aerodynamic performance, and a fuel efficiency of the vehicle by determining an opening rate of the AAF based on a relation between a cooling water temperature, a refrigerant pressure, and an intake air temperature.

The technical problems to be solved by the present inventive concept are not limited to the aforementioned problems, and any other technical problems not mentioned herein will be clearly understood from the following description by those skilled in the art to which the present disclosure pertains.

In one form, an active air flap control apparatus for a vehicle includes: a storing unit storing a plurality of critical values with respect to each of a cooling water temperature, a refrigerant pressure, and an intake air temperature; a first sensor measuring the cooling water temperature; a second sensor measuring the refrigerant pressure; a third sensor measuring the intake air temperature; and a controller relating the measure cooling water temperature, the measure refrigerant pressure, and the measured intake air temperature to each other. The controller determines an opening rate of an active air flap based on the plurality of critical values stored in the storing unit with respect to each of the cooling water temperature, the refrigerant pressure, and the intake air temperature.

The controller determines a priority with respect to the cooling water temperature, the refrigerant pressure, and the intake air temperature in order of the cooling water temperature, the refrigerant pressure, and the intake air temperature.

The controller determines the opening rate of the active air flap to about 0% when the cooling water temperature does not exceed a first critical value of the plurality critical values, the refrigerant pressure does not exceed a fourth critical value of the plurality critical values, and the intake air temperature does not exceed a seventh critical value of the plurality critical values.

The controller determines the opening rate of the active air flap to about 25% when the cooling water temperature does not exceed a second critical value of the plurality critical values, the refrigerant pressure does not exceed a fifth critical value of the plurality critical values, and the intake air temperature does not exceed an eighth critical value of the plurality critical values.

The controller determines the opening rate of the active air flap to about 50% when the cooling water temperature does not exceed a third critical value of the plurality critical values, the refrigerant pressure does not exceed a sixth critical value of the plurality critical values, and the intake air temperature does not exceed a ninth critical value of the plurality critical values.

The controller determines the opening rate of the active air flap to about 100% when the cooling water temperature exceeds a third critical value of the plurality critical values, the refrigerant pressure exceeds a sixth critical value of the plurality critical values, or the intake air temperature exceeds a ninth critical value of the plurality critical values.

The controller changes the plurality critical values based on an external environment.

According to another aspect of the present disclosure, an active air flap control method for a vehicle includes: allowing a storing unit to store a plurality of critical values with respect to each of a cooling water temperature, a refrigerant pressure, and an intake air temperature; allowing a first sensor to measure the cooling water temperature; allowing a second sensor to measure the refrigerant pressure; allowing a third sensor to measure the intake air temperature; and allowing a controller to relate the measured cooling water temperature, the measured refrigerant pressure, and the measured intake air temperature to each other, and determining by the controller an opening rate of an active air flap based on the plurality of critical values stored in the storing unit with respect to each of the cooling water temperature, the refrigerant pressure, and the intake air temperature.

The determining the opening rate includes determining a priority with respect to the cooling water temperature, the refrigerant pressure, and the intake air temperature in order of the cooling water temperature, the refrigerant pressure, and the intake air temperature.

The determining the opening rate includes determining the opening rate of the active air flap to about 0% when the cooling water temperature does not exceed a first critical value of the plurality of critical values, the refrigerant pressure does not exceed a fourth critical value of the plurality of critical values, and the intake air temperature does not exceed a seventh critical value of the plurality of critical values.

The determining the opening rate includes determining the opening rate of the active air flap to about 25% when the cooling water temperature does not exceed a second critical value of the plurality of critical values, the refrigerant pressure does not exceed a fifth critical value of the plurality of critical values, and the intake air temperature does not exceed an eighth critical value of the plurality of critical values.

The determining the opening rate includes determining the opening rate of the active air flap to about 50% when the cooling water temperature does not exceed a third critical value of the plurality of critical values, the refrigerant pressure does not exceed a sixth critical value of the plurality of critical values, and the intake air temperature does not exceed a ninth critical value of the plurality of critical values.

The determining the opening rate includes determining the opening rate of the active air flap to about 100% when the cooling water temperature exceeds a third critical value of the plurality of critical values, the refrigerant pressure exceeds a sixth critical value of the plurality of critical values, or the intake air temperature exceeds a ninth critical value of the plurality of critical values.

The determining the opening rate includes changing the plurality of critical values based on an external environment.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front view showing an active air flap (AAF) control system installed at a radiator grill of a vehicle;

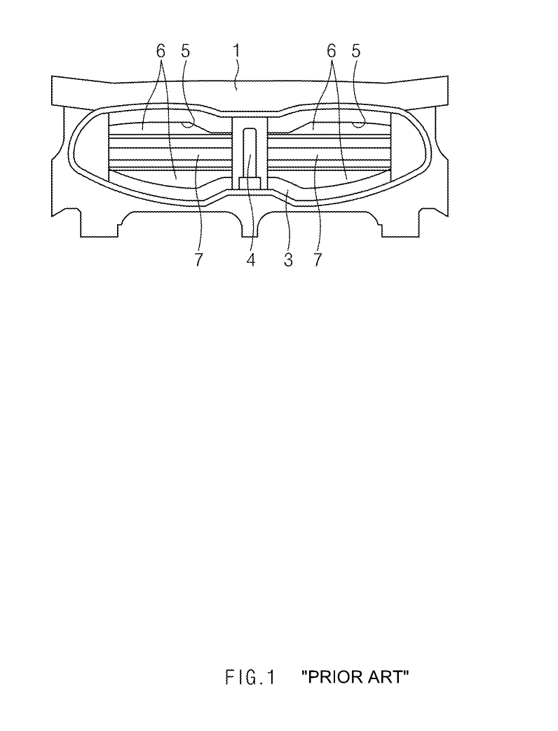

FIG. 2 is a side view showing the AAF control system installed at the radiator grill of the vehicle;

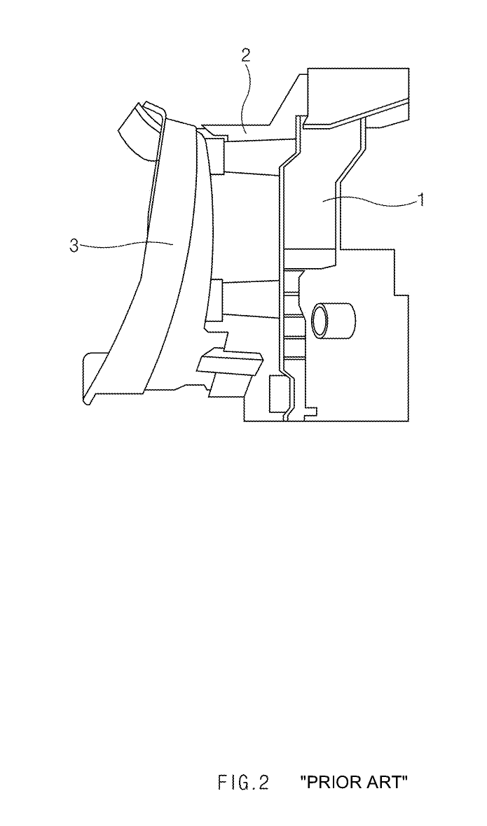

FIG. 3 is a block diagram showing an AAF control apparatus of a vehicle according to an exemplary form of the present disclosure;

FIG. 4 is a flowchart showing an AAF control method of a vehicle according to an exemplary form of the present disclosure; and

FIG. 5 is a flowchart showing a process of determining an opening rate of an AAF by using an AAF control apparatus according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The above and other objects, features and advantages of the present disclosure will be more clearly understood from the following detailed description taken in conjunction with the accompanying drawings, and thus the technical idea of the present disclosure will be embodied by those skilled in the art. Further, in the description of the present disclosure, when it is determined that the detailed description of the related art would obscure the gist of the present disclosure, the description thereof will be omitted.

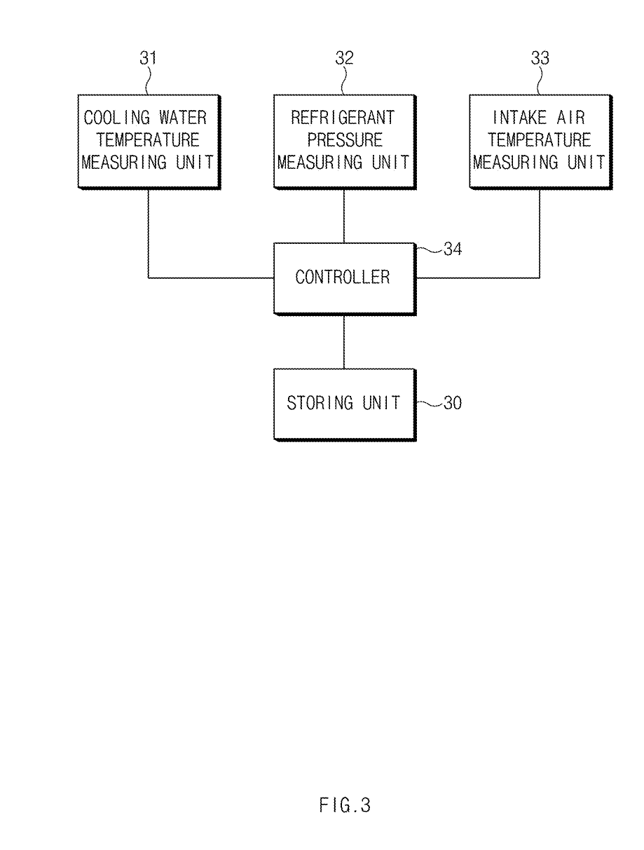

FIG. 3 is a block diagram showing an AAF control apparatus of a vehicle according to an exemplary form of the present disclosure.

As shown in FIG. 3, the AAF control system of the vehicle includes a storing unit 30, a cooling water temperature measuring unit 31, a refrigerant pressure measuring unit 32, an intake air temperature measuring unit 33, and a controller 34.

The storing unit 30 stores a plurality of critical values with respect to each of a cooling water temperature, a refrigerant pressure, and an intake air temperature.

That is, the storing unit 30 stores a first critical value (α), a second critical value (β), and a third critical value (γ) with respect to the cooling water temperature. In this case, the first, second, and third critical values with respect to the cooling water temperature satisfy the following inequalities: α<β<γ.

In addition, the storing unit 30 stores a fourth critical value (δ), a fifth critical value (ε), and a sixth critical value (ζ) with respect to the refrigerant pressure. In this case, the fourth, fifth, and sixth critical values with respect to the refrigerant pressure satisfy the following inequalities: δ<ε<ζ.

Further, the storing unit 30 stores a seventh critical value (η), an eighth critical value (θ), and a ninth critical value (ι) with respect to the intake air temperature. In this case, the seventh, eighth, and ninth critical values with respect to the intake air temperature satisfy the following inequalities: η<θ<ι.

Then, the cooling water temperature measuring unit 31 may be implemented by a resistive-type sensor to provide the controller 34 with information on the cooling water temperature of an engine. The engine cooling water temperature sensor is installed at a cooling water passage of an intake air manifold, and an engine control unit (ECU) determines a warming-up state of the engine based on an output voltage of the engine cooling water temperature sensor and controls a concentration of a fuel when a temperature of the engine is low.

The refrigerant pressure measuring unit 32 may be implemented by a sensor installed at a refrigerant high-pressure line of the engine compartment to measure the refrigerant pressure.

The intake air temperature measuring unit 33 may be implemented by a resistive-type sensor installed at an air flow sensor (AFS) to measure the intake air temperature. The ECU senses the intake air temperature based on an output voltage from the air temperature sensor and corrects a fuel injection quantity in response to the intake air temperature.

The controller 34 relates the cooling water temperature, the refrigerant pressure, and the intake air temperature to each other based on the critical values stored in the storing unit 30 with respect to each of the cooling water temperature, the refrigerant pressure, and the intake air temperature to determine an opening rate of the AAF. Here, the opening rate may be set to one of zero (0), first (1), second (2), or third (3) step. In this case, the zero (0) step indicates a state in which the AAF is completely closed, the first (1) step indicates a state in which the opening rate of the AAF is about 25%, the second (2) step indicates a state in which the opening rate of the AAF is about 50%, and the third (3) step indicates a state in which the opening rate of the AAF is about 100%.

In particular, the controller 34 determines a priority among the cooling water temperature, the refrigerant pressure, and the intake air temperature. That is, the controller 34 determines the cooling water temperature as a first rank, the refrigerant pressure as a second rank, and the intake air temperature as a third rank in order of greatest influence on the cooling performance, the aerodynamic performance, and the fuel efficiency of the vehicle. The priority means an order considered to determine the opening rate of the AAF.

Then, the controller 34 determines the opening rate of the AAF to the zero (0) step (close) when the cooling water temperature does not exceed the first critical value, the refrigerant pressure does not exceed the fourth critical value, and the intake air temperature does not exceed the seventh critical value.

In addition, the controller 34 determines the opening rate of the AAF to the first step when the cooling water temperature does not exceed the second critical value, the refrigerant pressure does not exceed the fifth critical value, and the intake air temperature does not exceed the eighth critical value.

In addition, the controller 34 determines the opening rate of the AAF to the second step when the cooling water temperature does not exceed the third critical value, the refrigerant pressure does not exceed the sixth critical value, and the intake air temperature does not exceed the ninth critical value.

In addition, the controller 34 determines the opening rate of the AAF to the third (fully open) step when the cooling water temperature exceeds the third critical value, the refrigerant pressure exceeds the sixth critical value, or the intake air temperature exceeds the ninth critical value.

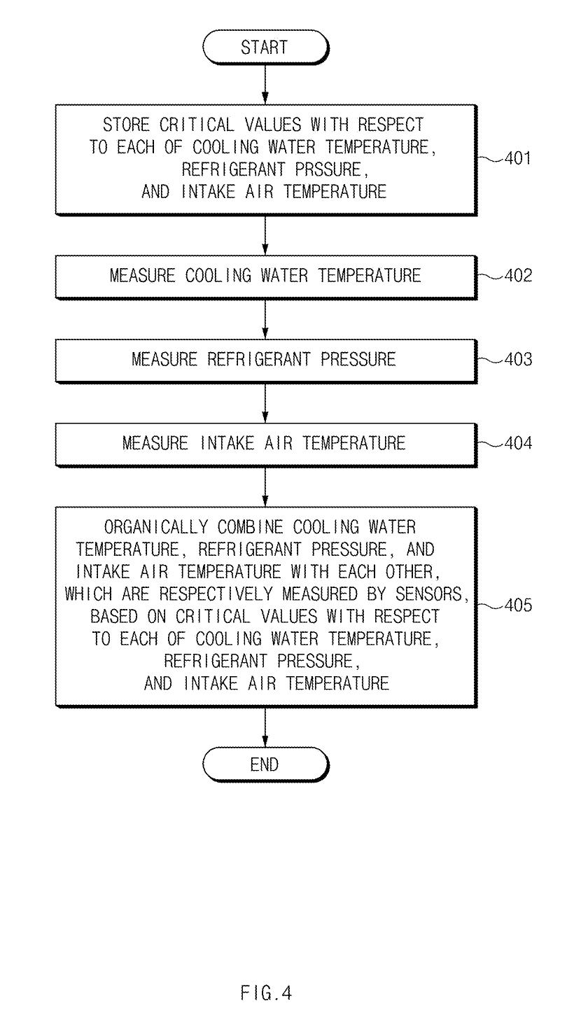

Detailed descriptions of the above will be described in detail later with reference to FIG. 4.

The process of determining the opening rate of the AAF is preferred to be applied to the vehicle in a low speed mode (e.g., equal to or smaller than about 30 KPH), but it should not be limited thereto or thereby.

Meanwhile, when the controller 34 compares the cooling water temperature measured by the cooling water temperature measuring unit 31 to each of the first critical value, the second critical value, and the third critical value, the controller 34 may change each of the first, second, and the third critical values in consideration of external environment, such as an air temperature outside of the vehicle, a speed of the vehicle, a high load driving condition (hill climbing of the vehicle), etc.

For instance, in a case that the air temperature outside of the vehicle is equal to or smaller than about zero (0) degrees Celsius, the controller 34 increases each of the first critical value, the second critical value, and the third critical value by a predetermined value.

In addition, when the controller 34 compares the refrigerant pressure measured by the refrigerant pressure measuring unit 32 to each of the fourth critical value, the fifth critical value, and the sixth critical value, the controller 34 may change each of the fourth, fifth, and sixth critical values in consideration of external environment, such as a power of an air conditioner, the speed of the vehicle, the high load driving condition, etc.

For instance, when the power of the air conditioner is higher than a reference value, the controller 34 determines that the engine is overheated and decreases each of the fourth critical value, the fifth critical value, and the sixth critical value by a predetermined value.

Further, when the controller 34 compares the intake air temperature measured by the intake air temperature measuring unit 33 to each of the seventh critical value, the eighth critical value, and the ninth critical value, the controller 34 may change each of the seventh, eighth, and ninth critical values in consideration of external environment, such as the air temperature outside of the vehicle, the speed of the vehicle, the high load driving condition, etc.

For instance, in a case that the outside air temperature is equal to or smaller than about zero (0) degrees Celsius, the controller 34 increases each of the seventh critical value, the eighth critical value, and the ninth critical value by a predetermined value.

FIG. 4 is a flowchart showing an AAF control method of a vehicle according to an exemplary form of the present disclosure.

First, the storing unit 30 stores the critical values with respect to each of the cooling water temperature, the refrigerant pressure, and the intake air temperature (401).

Then, the cooling water temperature measuring unit (a first sensor) measures the cooling water temperature (402).

After that, the refrigerant pressure measuring unit (a second sensor) measures the refrigerant pressure (403).

Then, the intake air temperature measuring unit (a third sensor) measures the intake air temperature (404).

The controller 34 receives the cooling water temperature, the refrigerant pressure, and the intake air temperature, which are respectively measured by the first, second, and third sensors, and determines an opening rate of the AAF based on the critical values with respect to each of the cooling water temperature, the refrigerant pressure, and the intake air temperature, which are stored in the storing unit 30.

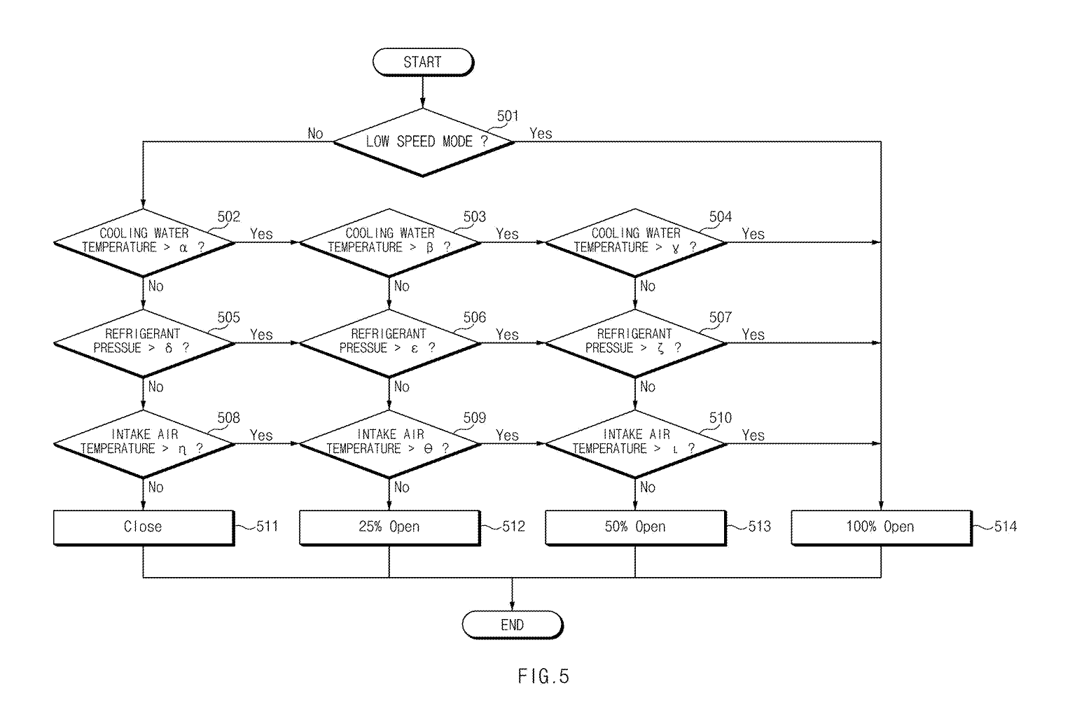

In this case, the process in which the controller 34 receives the cooling water temperature, the refrigerant pressure, and the intake air temperature, and determines the opening rate of the AAF will be described in detail with reference to FIG. 5.

FIG. 5 is a flowchart showing a process of determining an opening rate of an AAF by using an AAF control apparatus according to an exemplary form of the present disclosure.

First, it is determined whether the vehicle is in the low speed mode (e.g., equal to or less than about 30 KPH) (501).

When the vehicle is in the low speed mode based on the determined result (501), the opening rate of the AAF is determined to be about 100% (514).

When the vehicle is not in the low speed mode based on the determined result (501), it is determined whether the cooling water temperature exceeds the first critical value (502).

When the cooling water temperature exceeds the first critical value based on the determined result (502), it is determined whether the cooling water temperature exceeds the second critical value (503).

When the cooling water temperature does not exceed the first critical value based on the determined result (502), it is determined whether the refrigerant pressure exceeds the fourth critical value (505).

When the cooling water temperature exceeds the second critical value based on the determined result (503), it is determined whether the cooling water temperature exceeds the third critical value (504).

When the cooling water temperature does not exceed the second critical value based on the determined result (503), it is determined whether the refrigerant pressure exceeds the fifth critical value (506).

When the cooling water temperature exceeds the third critical value based on the determined result (504), the opening rate of the AAF is determined to be about 100% (514).

When the cooling water temperature does not exceed the third critical value based on the determined result (504), it is determined whether the refrigerant pressure exceeds the sixth critical value (507).

When the refrigerant pressure exceeds the fourth critical value based on the determined result (505), it is determined whether the refrigerant pressure exceeds the fifth critical value (506).

When the refrigerant pressure does not exceed the fourth critical value based on the determined result (505), it is determined whether the intake air temperature exceeds the seventh critical value (508).

When the refrigerant pressure exceeds the fifth critical value based on the determined result (506), it is determined whether the refrigerant pressure exceeds the sixth critical value (507).

When the refrigerant pressure does not exceed the fifth critical value based on the determined result (506), it is determined whether the intake air temperature exceeds the eighth critical value (509).

When the refrigerant pressure exceeds the sixth critical value based on the determined result (507), the opening rate of the AAF is determined to be about 100% (514).

When the refrigerant pressure does not exceed the sixth critical value based on the determined result (507), it is determined whether the intake air temperature exceeds the ninth critical value (510).

When the intake air temperature exceeds the seventh critical value based on the determined result (508), it is determined whether the intake air temperature exceeds the eighth critical value (509).

When the intake air temperature does not exceed the seventh critical value based on the determined result (508), the opening rate of the AAF is determined to be about 0% (511).

When the intake air temperature exceeds the eighth critical value based on the determined result (509), it is determined whether the intake air temperature exceeds the ninth critical value (510).

When the intake air temperature does not exceed the eighth critical value based on the determined result (509), the opening rate of the AAF is determined to be about 25% (512).

When the intake air temperature exceeds the ninth critical value based on the determined result (510), the opening rate of the AAF is determined to be about 100% (514).

When the intake air temperature does not exceed the ninth critical value based on the determined result (510), the opening rate of the AAF is determined to be about 50% (515).

Meanwhile, the above-mentioned method of the present disclosure may be implemented as a computer program. Codes and code segments constituting the computer program may be readily inferred by a computer programmer in the field. In addition, the computer program may be stored in computer-readable recording media and may be read and executed by a computer, thereby implementing the method of the present disclosure. In addition, the recording media includes all types of recording media that are computer-readable.

In one form of the present disclosure, the opening rate of the AAF is determined by intimately connecting the cooling water temperature, the refrigerant pressure, and the intake air temperature to each other, and thus the cooling performance, the aerodynamic performance, and the fuel efficiency may be improved.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An active air flap control apparatus for a vehicle, comprising:
a storing unit configured to store a plurality of critical values with respect to each of a cooling water temperature, a refrigerant pressure, and an intake air temperature;
a first sensor configured to measure the cooling water temperature;
a second sensor configured to measure the refrigerant pressure;
a third sensor configured to measure the intake air temperature; and
a controller configured to relate the measured cooling water temperature, the measured refrigerant pressure, and the measured intake air temperature to each other, and configured to determine an opening rate of an active air flap based on the plurality of critical values stored in the storing unit with respect to each of the cooling water temperature, the refrigerant pressure, and the intake air temperature.

2. The active air flap control apparatus of claim 1, wherein the controller is configured to determine a priority with respect to the cooling water temperature, the refrigerant pressure, and the intake air temperature in order of the cooling water temperature, the refrigerant pressure, and the intake air temperature.

3. The active air flap control apparatus of claim 2, wherein the controller is configured to determine the opening rate of the active air flap to about 0% when the cooling water temperature does not exceed a first critical value of the plurality of the critical values, the refrigerant pressure does not exceed a fourth critical value of the plurality of the critical values, and the intake air temperature does not exceed a seventh critical value of the plurality of the critical values.

4. The active air flap control apparatus of claim 2, wherein the controller is configured to determine the opening rate of the active air flap to about 25% when the cooling water temperature does not exceed a second critical value of the plurality of the critical values, the refrigerant pressure does not exceed a fifth critical value of the plurality of the critical values, and the intake air temperature does not exceed an eighth critical value of the plurality of the critical values.

5. The active air flap control apparatus of claim 2, wherein the controller is configured to determine the opening rate of the active air flap to about 50% when the cooling water temperature does not exceed a third critical value of the plurality of the critical values, the refrigerant pressure does not exceed a sixth critical value of the plurality of the critical values, and the intake air temperature does not exceed a ninth critical value of the plurality of the critical values.

6. The active air flap control apparatus of claim 2, wherein the controller is configured to determine the opening rate of the active air flap to about 100% when the cooling water temperature exceeds a third critical value of the plurality of the critical values, the refrigerant pressure exceeds a sixth critical value of the plurality of the critical values, or the intake air temperature exceeds a ninth critical value of the plurality of the critical values.

7. The active air flap control apparatus of claim 1, wherein the controller is configured to change the plurality of critical values based on an external environment.

8. An active air flap control method for a vehicle, the method comprising:
allowing a storing unit to store a plurality of critical values with respect to each of a cooling water temperature, a refrigerant pressure, and an intake air temperature;
allowing a first sensor to measure the cooling water temperature;
allowing a second sensor to measure the refrigerant pressure;
allowing a third sensor to measure the intake air temperature; and
allowing a controller to relate the measured cooling water temperature, the measured refrigerant pressure, and the measured intake air temperature to each other, and determining by the controller an opening rate of an active air flap based on the plurality of critical values stored in the storing unit with respect to each of the cooling water temperature, the refrigerant pressure, and the intake air temperature.

9. The method of claim 8, wherein the determining the opening rate comprises determining a priority with respect to the cooling water temperature, the refrigerant pressure, and the intake air temperature in order of the cooling water temperature, the refrigerant pressure, and the intake air temperature.

10. The method of claim 9, wherein the determining the opening rate comprises determining the opening rate of the active air flap to about 0% when the cooling water temperature does not exceed a first critical value of the plurality of critical values, the refrigerant pressure does not exceed a fourth critical value of the plurality of critical values, and the intake air temperature does not exceed a seventh critical value of the plurality of critical values.

11. The method of claim 9, wherein the determining the opening rate comprises determining the opening rate of the active air flap to about 25% when the cooling water temperature does not exceed a second critical value of the plurality of critical values, the refrigerant pressure does not exceed a fifth critical value of the plurality of critical values, and the intake air temperature does not exceed an eighth critical value of the plurality of critical values.

12. The method of claim 9, wherein the determining the opening rate comprises determining the opening rate of the active air flap to about 50% when the cooling water temperature does not exceed a third critical value of the plurality of critical values, the refrigerant pressure does not exceed a sixth critical value of the plurality of critical values, and the intake air temperature does not exceed a ninth critical value of the plurality of critical values.

13. The method of claim 9, wherein the determining the opening rate comprises determining the opening rate of the active air flap to about 100% when the cooling water temperature exceeds a third critical value of the plurality of critical values, the refrigerant pressure exceeds a sixth critical value of the plurality of critical values, or the intake air temperature exceeds a ninth critical value of the plurality of critical values.

14. The method of claim 8, wherein the determining the opening rate comprises changing the plurality of critical values based on an external environment.
